(19) United States
(12) Patent Application Publication
(10) Pub. No.: US 2011/0109468 A1
(43) Pub. Date: May 12, 2011

(54) SAFETY SYSTEM AND METHOD FOR PARTIAL DEACTIVATION OF A PERSONAL COMMUNICATION DEVICE WHILE VEHICLE IS IN MOTION

(76) Inventors: Robert A. Hirschfeld, Austin, TX (US); Laura G. Hirschfeld, Austin, TX (US); Gregory S. Althaus, Austin, TX (US)

(21) Appl. No.: 12/614,401

(22) Filed: Nov. 7, 2009

(51) Int. Cl. G08B 21/00

(52) U.S. Cl. 340/670

(57) ABSTRACT

A method of partial deactivation of a personal communication device in a vehicle when the vehicle is in motion including receiving, by the personal communication device, velocity information of the vehicle, determining, by the personal communication device, whether the vehicle is in motion from the velocity information, and deactivating, by an application executing on the personal communication device, at least one function of the personal communication device when the vehicle is in motion. Deactivation may include any one or more of disabling a user interface, turning off a communication radio, muting a ringer, and activating a power saving mode. A safety system for partial deactivation of the personal communication device while a vehicle is in motion. A diagnostic audio bridge retrieves and sends velocity information. The device executes activation control code which deactivates at least one function of the personal communication device when the vehicle is in motion.

### CROSS-REFERENCE TO RELATED APPLICATIONS

This application claims the benefit of U.S. Provisional Application Ser. No. 61/197,607, filed on Nov. 7, 2008 which is herein incorporated by reference in its entirety for all intents and purposes. The present application is also a continuation-in-part of copending U.S. patent application Ser. No. ______, entitled SYSTEM AND METHOD FOR COMMUNICATING ON-BOARD DIAGNOSTIC INFORMATION AS AN AUDIO SIGNAL, filed on Oct. 30, 2009, which is incorporated herein by reference in its entirety for all intents and purposes.

### BACKGROUND OF THE INVENTION

1. Field of the Invention

The present invention relates in general to driving safety concerns, and more particularly to partial deactivation of a personal communication device while a vehicle is in motion to prevent drivers from using the personal communication device while driving.

2. Description of the Related Art

Vehicle On-Board Diagnostics (OBD) interfaces are standardized by statute on all modern vehicles. These interfaces conforms to both physical and protocol specifications. The communication protocols used by OBD include serial (e.g.: RS-232) and controller area network (CAN). There are at least 5 different standards based protocol specifications in use for current OBD systems including SAE J1850 PWM/VPW, ISO 9141-2, ISO 14230 KWP2000, and ISO 15765 CAN. Starting in 2008, all US vehicles must use ISO 15765 CAN based communication protocols for the OBD interface. Various standards are known for OBD, such as OBD-I, OBD 1.5, and OBD-II which include various standard interfaces, signal protocols, data communications, etc. The present disclosure contemplates future OBD configurations and implementations.

In many applications, OBD interfaces are normalized using a translation microcontroller such as the ELM from SK Pang Electronics. The ELM is able to translate the different OBD protocols into a single protocol; however, the communication interface with the ELM remains serial. Some applications of the ELM or related translators have been adapted to use wireless communications BlueTooth™. These implementations rely on digital serial communication via BlueTooth™ that is not natively supported on many personal communication devices including smart phones.

Navigation computers are used in many vehicle applications as both installed and after-market additions. Vendors of these computers use global positioning systems (GPS) signals to provide interactive navigation assistance for drivers. Makers of these devices include Garmin® and TomTom®. The capability of navigation computers is expanding to include bidirectional information and to incorporate other location based services.

Smart phones have been widely available from companies such as Research In Motion (RIM). Recent introduction of the iPhone® by Apple Inc. and Android by Google phones have accelerated market penetration of these devices. Smart phones provide a broad range of capabilities, such as large readable displays, the ability to add new applications to the phone, network connectivity via cellular and/or WiFi, and global positioning system (GPS) location determination.

OBD display devices from companies including Autotap, ScanGauge allow drivers to display diagnostic data using a dedicated device and display. These after-market products allow drivers to monitor car diagnostics including fuel economy. Integrated vehicle diagnostic displays are included in some automobile dashboards or displays to show current and average fuel economy.

### BRIEF DESCRIPTION OF THE DRAWINGS

The benefits, features, and advantages of the present invention will become better understood with regard to the following description, and accompanying drawings where:

FIG. 1 is a block diagram of an audio communication system including an on-board diagnostics system and a personal communication device coupled to communicate via a wired electronic interface;

FIG. 2 is a block diagram of an audio communication system including the OBD system coupled to the DAB via the OBD interface as shown in FIG. 1, and the PCD coupled to communicate via a wireless interface;

FIG. 3 is a block diagram of an audio communication system including the OBD system coupled to the DAB via the OBD interface of FIG. 1, and the PCD coupled to communicate using a sound signal;

FIG. 4 illustrates an example of an encoding routine written in Java that creates a PCM data buffer that represents the sound to be sent out an audio port;

FIG. 5 illustrates an example of a Java decoding routine that receives a buffer of PCM data from an audio port;

FIG. 6 is a block diagram illustrating the encoder/decoder pair used in a system stack including hardware, system APIs, the encoder/decoder, a business logic layer, and a presentation layer

FIG. 7 is a block diagram of an audio communication system in which the PCD of FIG. 1 is configured with part of a safety system for partial deactivation in the event of vehicle motion; and

FIG. 8 is a block diagram of an audio communication system substantially similar to the system of FIG. 7 except further including a location sensor coupled to the user interface control application.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

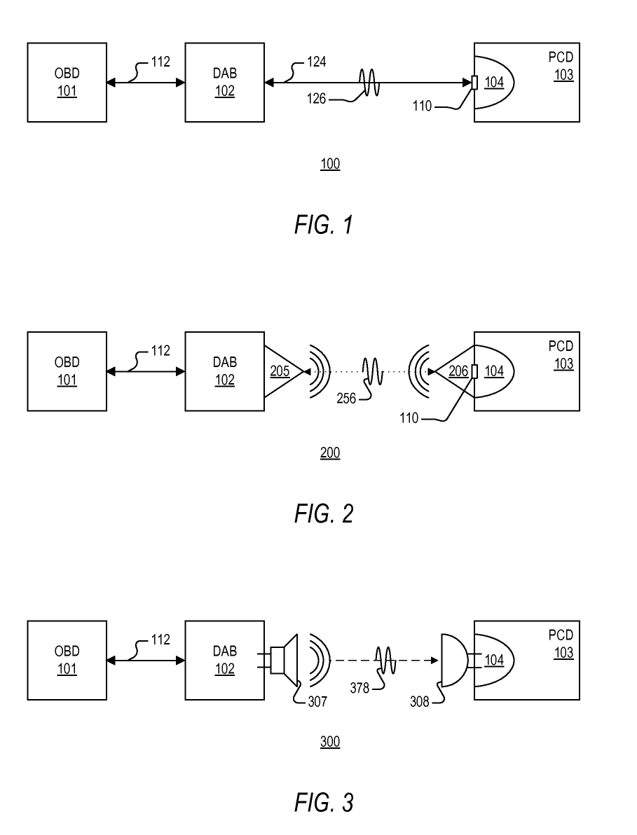

FIG. 1 is a block diagram of an audio communication system 100 including an on-board diagnostics (OBD) system 101 and a personal communication device (PCD) 103 coupled to communicate via a wired electronic interface 124. The wired electronic interface 124 may include a single conductor for serial communications, in which multiple conductors may be used to facilitate bidirectional communications (at least one conductor for each direction). A diagnostic audio bridge (DAB) 102 is coupled to the OBD system 101 via an OBD interface 112. In one embodiment, the DAB 102 is a physical device with an embedded communication module. The OBD system 101 includes a standard OBD connector or the like, and the OBD interface 112 includes a direct connector to connector coupling or a cable interface or the like. For example, the OBD system 101 includes an OBD-type connector compatible to directly plug into the standard OBD connector, or the OBD system 101 is coupled to the OBD system 101 via an appropriate cable or the like which plugs into the OBD connector. The DAB 102 interfaces the PCD 103 via the wired electronic interface 124 which includes one or more conductive wires to facilitate communications.

As illustrated, the DAB 102 communicates directly with the OBD system 101 to retrieve diagnostic data, to modulate the diagnostic data into an audio signal 126, and to transmit the audio signal 126 to the PCD 103 via the wired electronic interface 124. The PCD 103 includes a communication service 104, which demodulates the audio signal 126 to retrieve the diagnostic data and to incorporate the data into the appropriate format for consumption by the PCD 103. In a bidirectional configuration, the communication service 104 incorporates requests or commands or instructions or the like into the audio signal 126 which is transmitted to the DAB 102 via the wired electronic interface 124. In the bidirectional configuration, the DAB 102 incorporates similar functions as the communication service for decoding the received analog signal 126, retrieving instructions, commands, requests, etc., and interfacing the OBD system 101 accordingly. In one embodiment, the communication service 104 is an application executed on the PCD 103, such as an application configured for a smart phone or the like. The use of a wired interface ensures that communication is restricted between the two devices, but limits the location and connections for the system.

In one embodiment, the wired electronic interface 124 connects to the PCD 103 via an audio input/output connector 110. The connector 110 on the PCD 103 has any one of many different formats depending upon its implementation. There are two dominate form factors although any other suitable form factor may be used. A first form factor is the TRRS (tip-ring-ring-shield) audio jack plug that connects the microphone input and right/left audio channels of a smart phone. Another form factor is a proprietary control plug unique to each vendor and/or model. The proprietary interfaces generally provide for a microphone input and right/left audio channels. The plug may also have additional capabilities such as recharging the PCD 103. These extra capabilities may make the proprietary connector a more desirable interface in some applications, such as charging or maintaining charge of the PCD 103 during use.

In one embodiment, the communication is unidirectional in which the audio signal 126 is effectively “broadcasted” to the PCD 103. The unidirectional broadcast configuration has an advantage by reducing or eliminating bidirectional protocol translation between the OBD system 101 and the PCD 103. In an alternative embodiment, the communication is bidirectional. In a bidirectional configuration, the PCD 103 may periodically poll the OBD system 101 for OBD data or information or may send commands or requests for specific OBD data and information, such as according to OBD codes and the like as understood by those skilled in the art.

FIG. 2 is a block diagram of an audio communication system 200 including the OBD system 101 coupled to the DAB 102 via the OBD interface 112, and the PCD 103 coupled to communicate via a wireless interface. The DAB 102 includes or is otherwise coupled to a wireless audio transceiver 205 which wirelessly communicates with another wireless transceiver 206 coupled to the PCD 103. In this case the audio signal 126 is encoded and wirelessly transmitted as a wireless signal 256 from one of the transceivers 205 and 206 to the other, in which the receiving transceiver decodes the wireless signal back into the audio signal 126. The communication service 104 operates in substantially the same manner for decoding the wireless signal 126 into the OBD data or information. The term “transceiver” as used herein means a transmitter, a receiver, or a combination of both depending upon the particular configuration. In a unidirectional or broadcast configuration, the transceiver 205 includes a transmitter and the transceiver 206 includes a receiver. In a bidirectional configuration, both transceivers 205 and 206 include transmitters and receivers, and the communication service 104 encodes information (e.g., data, requests, commands, etc.) from the PCD 103 for transmission to the OBD system 101. Although the transceiver 206 may be integrated within the PCD 103, the transceiver 206 may alternatively be implemented as a separate device which plugs into the connector 110 on the PCD 103.

In one embodiment, the wireless signal 256 is according to a digital wireless audio (DWA) protocol. In one embodiment, the transceivers 205 and 206 are implemented according to BlueTooth™, which uses an open wireless protocol for exchanging data over short distances. The wireless transceivers 205 and 206 enable bidirectional wireless communications between the OBD system 101 and the PCD 103. In one embodiment, the wireless interface provides a meta-channel for control signals in which the PCD 103 sends instructions to the OBD system 101 via the DAB 102, such as for requesting particular data or the like. In an alternative broadcast embodiment, 205 is implemented as a wireless transmitter and 206 as a wireless receiver.

When the signal is transmitted using digital wireless protocols such as BlueTooth™ or the like, then it may be desired to alter the encoding strategy or data rates. This need arises because the digital wireless protocol may include data compression that is performed to convert the analog signal into a wireless digital signal. When the wireless signal is decoded back to audio, there may be a loss of fidelity that may impair the decoding algorithms reducing data transmission rate.

FIG. 3 is a block diagram of an audio communication system 300 including the OBD system 101 coupled to the DAB 102 via the OBD interface 112, and the PCD 103 coupled to communicate using a sound signal 378. In the illustrated embodiment, the audio signal 126 generated by the DAB 102 is broadcast as the sound signal 378 using a speaker 307 integrated on or otherwise coupled to the DAB 102. The sound signal 378 is received by a microphone 308 on the PCD 103 and converted to the audio signal 126, in which the audio signal 126 is provided to and processed by the communication service 104 in a similar manner as previously described. In one embodiment, the microphone 308 is an integrated microphone provided on the PCD 103, such as typically included on smart phones and the like. Alternatively, the microphone 308 is a separate device which plugs into the connector 110 on the PCD 103. The audio encoding used by the systems 200 or 300 may be identical and should not effect display applications on the PCD 103 or processing applications on the DAB 102. In one embodiment, the sound signal 378 is inaudible to humans, although sound audible to humans is also contemplated.

In an alternative embodiment, the communication system 300 is extended to reverse communication between the PCD 103 and the DAB 102. Bidirectional communication is established by using a speaker (not shown) on the PCD 103 and a corresponding microphone (not shown) coupled to the DAB 102.

An audio communication between the OBD system 101 and a PCD 103 as described herein circumvents the lack of direct serial communication support in current generation smart phones such as Apple's iPhone™, Google's Android™-based phones, and RIM's BlackBerry™. This limitation prevents external systems from communicating directly with the device for a variety of applications. In one embodiment, a communication system as described herein changes the communication model from point-to-point to broadcast.

At least one application for an audio communication between the OBD system 101 and a PCD 103 as described herein is to allow a vehicle OBD system to report current performance status to a monitoring application running on a smart phone. The communication pattern is strongly unidirectional and well suited to broadcast. This communication system is valuable because drivers can use vehicle diagnostic information from OBD to drive more efficiently and improve gas mileage. Diagnostic information may also be used to alert drivers about vehicle performance and maintenance issues. Based on information from extreme drivers, otherwise known as “hypermilers”, awareness of vehicle performance may be used to improve gas mileage by 20% or more. Improved gas mileage is a significant benefit particularly when gas prices rise.

It is anticipated that an audio communication between the OBD system 101 and a PCD 103 as described herein is generally applicable for other applications in which external communication with a smart phone is desired. For example, the communication system as described herein enables external communication with parking meters, machine-controlled telescopes, digital cameras, physical access control systems, and home or building automation control systems.

The vehicle specific part of the communication system employs a device (e.g., the DAB 102) that can communicate digitally with the OBD system. The DAB encodes and relays the digital performance data into audio signals. In an alternative embodiment, vehicle systems generate the audio signal 126 directly so that the DAB may be omitted. Smart phones are universally well-equipped to receive and process audio signals.

The OBD information is audio encoded in many ways including, but not limited to, methods employed by conventional modems. These approaches include, but are not limited to, highly discrete amplitude modulation, such as using 256 volume levels to encode a byte in a single pulse, discrete amplitude modulation, such as using 3 volume levels (on/off/space) to encode a bit in a single pulse, overlapping frequency modulation, such as using 256 audio overlapping frequencies to encode a byte, discrete frequency modulation, such as using 256 discrete frequencies to encode a byte, etc. A combination of amplitude and frequency modulation is also contemplated. It is desired to standardize on a single encoding approach to minimize decoding complexity. There are multiple mechanisms for the DAB to encode digital signals, including, but not limited to, recording waveforms for bits and playing them in the correct sequence, using a fast Fourier transform (FFT) or similar mathematical approach to generate the correct signals, using frequency generating electronics and combining them using analog circuits, etc.

As previously described, the encoding/decoding functions of the communication service 104 operate on both ends of the channel for bidirectional communication. The communication service 104 can be implemented in many different forms. For example, on the iPhone Objective C, the native programming language of the iPhone, can interpret the audio signal from the phone into digital data. The iPhone provides the audio signal as pulse code modulation (PCM) format information. On an Android-based phone, a Java program is preferred for the audio decoder. The Java application programming interface (API) also supplies a PCM signal. In one embodiment, a C or Assembly language program is used on the DAB 102 to decode the signals into digital data. In one embodiment, frequency counter integrated circuits (ICs) are used on the DAB 102 to simplify the decoding programs.

In general, encoding data is simpler than decoding because lookup tables can be used to map bit or byte patterns into PCM sound wave. The PCM data is delivered to the relevant API and translated by the system's operating system into sound. The DAB 102 has fewer support APIs and may use a digital to analog IC instead of a PCM interface.

Some implementations may not be able to use PCM input because the operating system does not provide a PCM formatted input. PCM is preferred because it is considered lossless. In non-PCM embodiments, the input audio is provided in an compressed format using one of the industry standard audio encodings such as MP3, 3GP, WAV etc. In these cases, the audio signal 126 has been substantially altered and frequencies have been eliminated from the data. One approach is to convert the signal back to PCM for use in the algorithms described above. An alternative approach, compressed pattern matching (CPM), is used to find frequency patterns in the encoded data based on a table lookup model. In the CPM application, knowledge of the encoding algorithm allows the CPM algorithm to inspect frames of the encoded data. Frames with similar encoding values are known to match certain frequencies. Lack of controllable frame boundaries requires additional padding between frequencies; consequently, the available bandwidth for CPM is limited.

An audio communication between the OBD system 101 and a PCD 103 as described herein allows for bidirectional communication between devices using at least two modes. A first mode relies on the same audio encoding methodology as described above. BlueTooth™ and similar technologies are bidirectional by design when both audio channels are used. Encoding using a sound via a microphone and speaker includes timing or noise cancellation to prevent signal collisions. A second mode employs the meta data or audio control channel of the digital audio encoding protocol. The control channel is used to manage mute and volume levels. Bidirectional communication is established by manipulating these control values to encode digital data. In one embodiment, a nibble is encoded as one of 16 discrete volume levels while mute on/off marks each nibble.

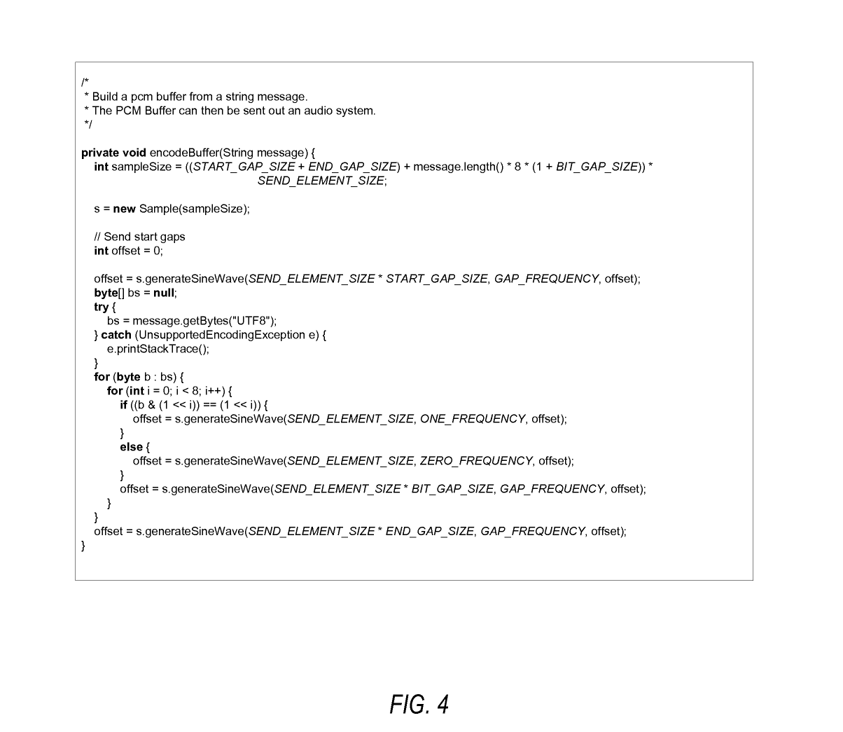

FIG. 4 illustrates an example of an encoding routine written in Java that creates a PCM data buffer that represents the sound to be sent out an audio port. Java and iPhone OS have APIs that allow for sending a PCM buffer to a speaker. The exemplary code shown in FIG. 4 is only one of many forms of encoding that could be used to transmit and receive data over an audio system. The encoding/decoding method illustrated herein is relatively robust in handling noise in the signal.

According to the encoding routine of FIG. 4, the data is encoded into a pulse-code-modulated (PCM) buffer. The PCM buffer is a collection of 16-bit samples over period of time. Assuming 14,400 samples per second, 1 second of sound is represented by 14,400 samples. The buffer is filled by generating one of three data patterns and appending them together in the buffer. Each data pattern is a sine wave pattern that cycles at a chosen frequency. The function, generateSineWave, builds the sine pattern into the buffer for a given number of samples assuming the 14,400 samples. For example, an 800 Hertz (Hz) wave defined by a sine function goes from 0 to 1 back to 0 to −1 and back to 0 800 times in one second. The sine functions output is scaled to fit inside 16 bits of value. Once constructed, the buffer is sent out the audio system to be played on the speaker. The encoding routine uses three frequencies to encode the data in 50 sample elements. Each 50 sample element represents a 1 bit, a 0 bit, or a gap. The data is taken a bit at a time and encoded by putting the appropriate 1 or 0 bit into the sample followed by a gap. The gap is used to make sure that decoder has found the boundaries of the bits.

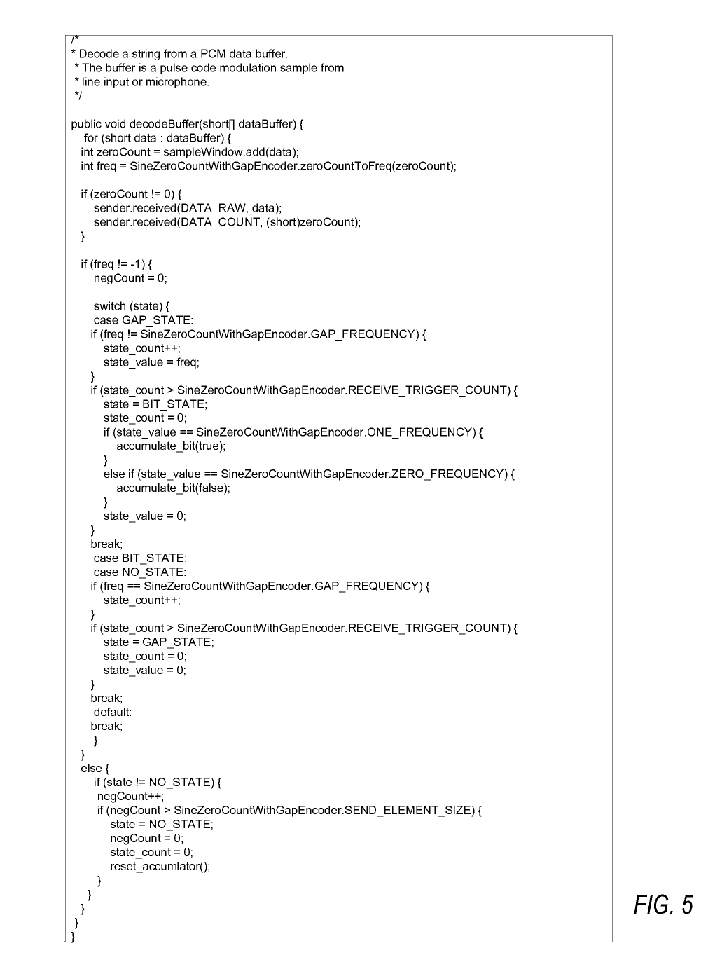

FIG. 5 illustrates an example of a Java decoding routine that receives a buffer of PCM data from an audio port. The routine converts the data buffer into a stream of bytes. Java and iPhone OS have APIs that allow for receiving a PCM buffer from a microphone or line input. The illustrated code is one of many forms of decoding that may be used to transmit and receive data over an audio system. The encoding/decoding method illustrated herein is relatively robust in handling noise in the signal.

The encoder takes a PCM buffer from a microphone. The buffer contains 16-bit samples of the microphone at a frequency of 14,400 samples per second. The encoder looks for 50 samples that have a transition of a specific amount. Since the data was encoded as sine waves, the samples cross the 0 line a number of times. Each frequency crosses the 0 line a defined number of times for that frequency within the 50 sample unit. The decoder looks at the moving value of zero value crossing to see if it finds a sending frequency. The decoder uses the fact that a gap is sent between the bits of data to frame the data. The decoder acts as a state machine expecting a gap. Once a gap is found, it expects either a 0 or 1 signal. That bit of information is recorded and a gap is expected. This continues until two gaps are seen. Once 8 bits are seen, they are converted into an 8-bit number and stored in an array. These are accumulated and built into a string of information.

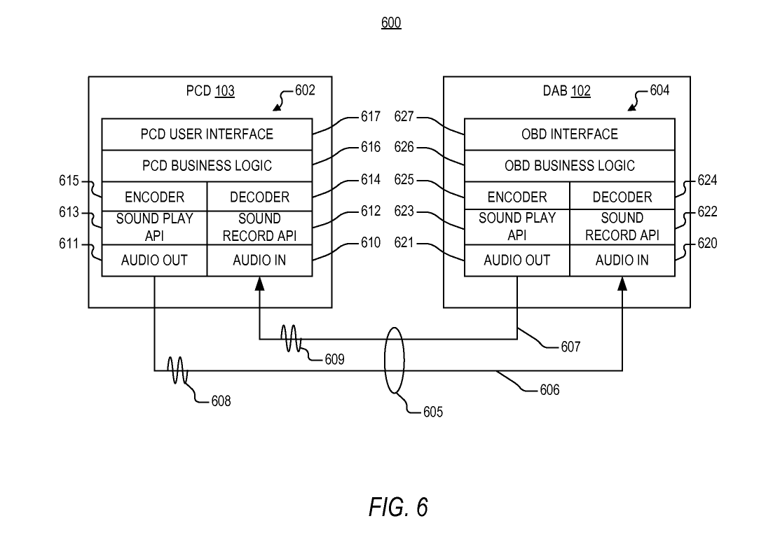

FIG. 6 is a block diagram of an audio communication system 600 according to one embodiment including a PCD stack 602 provided the PCD 103 and a DAB stack 604 provided on the DAB 102. The audio communication system 600 illustrates the encoder/decoder pair used in each system stack, in which each stack includes hardware, system APIs, the encoder/decoder, a business logic layer, and a presentation layer. The stacks 602 and 604 communicate via a communication interface 605, which is wired or wireless as previously described. The communication interface 605 includes a first channel 606 for sending audio signals 608 from the PCD stack 602 to the OBD stack 604, and a second channel 607 for sending audio signals 609 from the PBD stack 604 to the PCD stack 602. The communication interface 605 includes the appropriate cable and connectors for a wired configuration. The communication interface 605 includes corresponding transceivers (transmitter, receiver, or combination of both) for a wireless configuration. In a sound transmission case such as according to FIG. 3, the audio output for each stack is a speaker and the audio input is a microphone, in which the audio signals 608 and 609 are transmitted as audible or inaudible sound.

The PCD stack 602 includes a hardware layer including an audio input 610 and an audio output 611, system API's including a sound recording API 612 interfacing the audio input 610 and a sound play API 613 interfacing the audio output 611, a decoder 614 interfacing the sound recording API 612, an encoder 615 interfacing the sound play API 613, a PCD business logic layer 616 interfacing the encoder 615 and decoder 614, and a PCD user interface 617 interfacing the PCD business logic 616. In a similar manner, the OBD stack 604 includes a hardware layer including an audio input 620 and an audio output 621, system API's including a sound recording API 622 interfacing the audio input 620 and a sound play API 623 interfacing the audio output 621, a decoder 624 interfacing the sound recording API 622, an encoder 625 interfacing the sound play API 623, an OBD business logic layer 626 interfacing the encoder 625 and decoder 624, and an OBD interface 627 interfacing the OBD business logic 626 and for communicating with the OBD system 101.

In one embodiment, the PCD user interface 617 is an application that presents OBD data from the OBD system 101 of a vehicle (e.g., automobile) and directs the PCD business logic 616 to query for additional data elements. The OBD interface 627 drives the serial interface to an OBD data port. In each case, the business logic is responsible for handling the conversion of transmitted data received from the decoder into presentation views. It is also responsible for pushing data through the encoder from the presentation layer.

As a more specific example, suppose the PCD user interface 617 displays an RPM gauge on the PCD 103 representing engine RPMs from a car to which it is attached. The PCD user interface 617 displays the current RPM value. The job of the PCD business logic 616 is to make sure that this RPM value is always current. The PCD business logic 616 constructs and sends a request message to the OBD business logic 626 asking for the RPM value. The encoder 615 encodes the request message as sound or audio data in a PCM buffer and passes the PCM buffer to the sound play API 613. The sound play API 613 plays the audio data in the PCM buffer on the audio output 611 for transmission as the audio signal 608 to the audio input 620 of the OBD stack 604. The audio input 620 receives the audio signal 608 and converts the sound or audio data into data stored in a PCM buffer that the decoder 624 receives through the Sound recording API 622. The decoder 624 decodes the data in the PCM buffer into an OBD business logic request. The OBD business logic 626 takes that request and forwards a request to the OBD interface 627 for the current RPM value. The OBD interface 627 retrieves the new RPM value from the OBD system 101.

The OBD interface 627 gives the new RPM value to the OBD business logic 626. The OBD business logic 626 encodes the result as a message to the PCD business logic 616. The OBD business logic 626 passes the message to the encoder 625. The encoder 625 encodes the message as sound data in a PCM buffer and stores the data into a PCM buffer that represents the message containing the new RPM value. The encoder 625 “plays” the data in the PCM buffer through the Sound play API 623 and the audio output 607 as an audio signal 607. The audio input 610 “hears” the audio signal 607 and delivers corresponding data stored in a PCM buffer to the decoder 614 through the sound recording API 612. The decoder 614 converts the data in the PCM buffer to a message that contains the RPM value and passes that to the PCD business logic 616. The PCD business logic 616 then updates the current RPM value which causes the PCD user interface 617 to update its RPM gauge. This process repeats to keep the RPM gauge updated.

Other strategies may be used to reduce messaging by having the OBD business logic send an RPM value update at an interval. This takes a similar messaging style as that shown and described.

The number of traffic fatalities due to texting while driving has been steadily increasing. A system and method according to embodiments described herein at least partially deactivates the device for improved safety. The information about the speed of the vehicle is sent to a device, such as a smart phone or the like, and this information is used to disable selected functions while the vehicle is in motion. This provides a significant safety benefit to drivers because they are less distracted while driving. The degree of disablement varies depending on the application desired. Possible actions while driving include one or more of completely disabling the user interface, disabling text message capabilities, disabling receiving phone calls, and/or activating power save mode, among other actions.

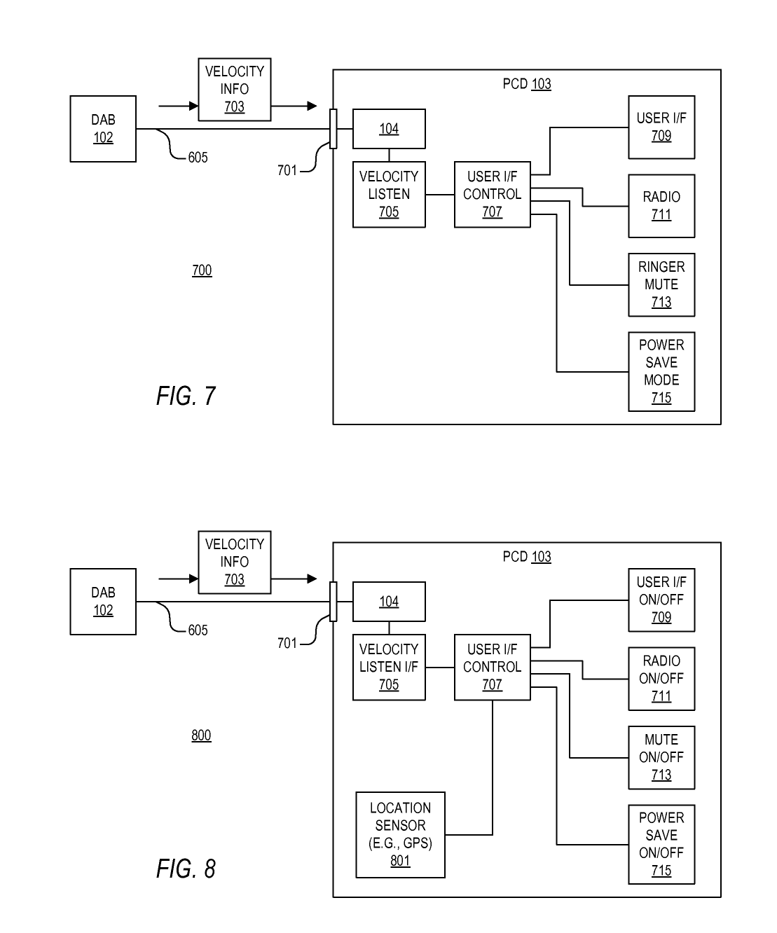

FIG. 7 is a block diagram of an audio communication system 700 including the DAB 102 coupled via the communication interface 605 to the PCD 103, in which the PCD 103 is configured with part of a safety system for partial deactivation in the event of vehicle motion. The communication interface 605 is configured according to any of the wired or wireless interfaces previously described, such as shown in any of the audio communication systems 100, 200 or 300. The communication interface 605 enables communication between the DAB 102 and the communication service 104 of the PCD 103 via an audio interface 701 as previously described. The communication service 104 is further interfaced with a velocity listening module 705, which is interfaced with a user interface control module 707. The communication service 104, velocity listening module 705, and the user interface control module 707 collectively operate as activation control code for partially deactivating the PCD 103 when the vehicle is in motion. The term “code” encompasses any combination of software, programs, applications, tasks, firmware or the like executed or otherwise operated or performed on the PCD 103. In one embodiment, the velocity listening module 705 is operated as a background task. In one embodiment, the user interface control module 705 is an application. In one embodiment, the modules described herein are tasks, operations, functions, applications, etc., which are executed on the PCD 103. Alternatively, the modules may be implemented as circuitry or the like. The user interface control module 707 controls the status of various functions of the PCD 103, such as a user interface 709, a radio 711, a ringer mute 713, and a power save mode 715. In one embodiment, the user interface control module 707 operates as business logic. The radio 711 is used for telecommunications of the PCD 103, such as cellular communications and the like.

The DAB 102 provides velocity information 703 to the PCD 103 via the communication interface 605 and the communication service 104. In one embodiment, the DAB 102 periodically broadcasts the velocity information 703, and in another embodiment the PCD 103 request the velocity information 703 and the DAB 102 responds by retrieving and sending the velocity information 703. In one embodiment, the velocity information 703 is modulated into an audio signal. The audio signal may be sent via a wired or wireless interface as previously described. The velocity listening interface 705 detects the velocity information 703 and determines whether the vehicle is moving or stopped. The velocity listening interface 705 communicates the vehicle status to the user interface control application 707, which controls any one or more of the function blocks 709, 711, 713 and 715 accordingly. The user interface control application 707 enables the user interface 709 when the vehicle is stopped or disables the user interface 709 when the vehicle is moving, turns on the radio 711 when the vehicle is stopped or turns off the radio 711 when the vehicle is moving, enables the ringer (by turning off ringer mute) when the vehicle is stopped or mutes the ringer when the vehicle is moving, and/or turns off the power save function 715 of the PCD 103 when the vehicle is stopped or turns on the power save function 715 when the vehicle is moving. Any combination of these actions is performed depending upon the situation, user preferences, and motion status of the vehicle.

The DAB 102 retrieves vehicle speed/velocity information 703 from the OBD 101 and provides it to the communication service 104 running on the PCD 103, where the information 703 is ultimately provided to the user interface control application 707. If the vehicle is not in motion, the PCD 103 operates normally. Once vehicle motion is detected, the user interface control application 707 takes any one or more of several possible actions to limit access by the vehicle driver or to otherwise limit usefulness of the PCD 103. The actions include, but are not limited to, turning off the screen or activating the screen saver of the PCD 103, turning off the sounds, turning off the external network access, temporarily holding alerts in a queue, activating power save mode, disabling user interface, disabling incoming communications, etc. One action is to deactivate the radio, also known as “airplane mode,” to ensure that incoming calls and texts are blocked. Another action is to mute the device's alerts. These examples are intended to be illustrative. There are numerous ways to disable user interfaces depending on the programming interfaces exposed by the device manufacturer.

FIG. 8 is a block diagram of an audio communication system 800 substantially similar to the system 700 except further including a location sensor 801 coupled to the user interface control application 707. The location sensor 801 may be implemented in any one of several manners, such as a global positioning system (GPS) or the like. It is noted that many personal communication devices include an embedded GPS sensor providing location information. A GPS sensor or the like providing motion information is disclosed, such methods are considered less reliable. For example, while it is possible to use motion or GPS sensors embedded in typical smart phones, these methods are general and not specifically linked to actual vehicle speed. Furthermore, they may be confused if the user is a passenger in another car or a bus.

A method of partial deactivation of a personal communication device in a vehicle when the vehicle is in motion according to one embodiment includes receiving, by the personal communication device, velocity information of the vehicle, determining, by the personal communication device, whether the vehicle is in motion from the velocity information, and deactivating, by an application executing on the personal communication device, at least one function of the personal communication device when the vehicle is in motion.

The method may include receiving velocity information from an on-board diagnostic system of the vehicle. The method may include retrieving, by a diagnostic audio bridge coupled to an on-board diagnostic system of the vehicle, the velocity information from the on-board diagnostic system, modulating, by a diagnostic audio bridge, the information into an audio signal, transmitting, by a diagnostic audio bridge, the audio signal within the vehicle, receiving, by a communication service operating on the personal communication device, the audio signal, and demodulating, by the communication service, the audio signal to receive the velocity information. The transmitting may be wireless. The method may include disabling a user interface of the personal communication device when the vehicle is in motion. The method may include turning off a communication radio of the personal communication device when the vehicle is in motion. The method may include muting a ringer of the personal communication device when the vehicle is in motion. The method may include activating a power saving mode of the personal communication device when the vehicle is in motion.

A safety system is disclosed herein for partial deactivation of a personal communication device while a vehicle is in motion, in which the vehicle includes an on-board diagnostic system. The safety system includes a communication link, a diagnostic audio bridge, and activation control code. The diagnostic audio bridge interfaces the communication link and is for coupling to the on-board diagnostic system of the vehicle. The diagnostic audio bridge retrieves velocity information of the vehicle from the on-board diagnostic system and transmits the velocity information via the communication link. The activation control code, which is for executing on the personal communication device, receives the velocity information and deactivates at least one function of the personal communication device when the vehicle is in motion.

The communication may be wired or wireless and the velocity information may be modulated into an audio signal. The activation control code may include a velocity listening module and a user interface control application. The velocity listening module detects the velocity information and which determines when the vehicle is in motion. The user interface control application deactivates at least one function of the personal communication device when the vehicle is in motion. The activation control code may disable a user interface of the personal communication device when the vehicle is in motion. The activation control code may turn off a communication radio of the personal communication device when the vehicle is in motion. The activation control code may mute a ringer of the personal communication device when the vehicle is in motion. The activation control code may activate a power saving mode of the personal communication device when the vehicle is in motion.

Although the present invention has been described in considerable detail with reference to certain preferred versions thereof, other versions and variations are possible and contemplated. For example, circuits or logic blocks or modules described herein may be implemented as discrete circuitry or integrated circuitry or software or any alternative configurations. Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A method of partial deactivation of a personal communication device in a vehicle when the vehicle is in motion, comprising:
receiving, by the personal communication device, velocity information of the vehicle;
determining, by the personal communication device, whether the vehicle is in motion from the velocity information; and
deactivating, by an application executing on the personal communication device, at least one function of the personal communication device when the vehicle is in motion.

2. The method of claim 1, wherein said receiving velocity information comprises receiving velocity information from an on-board diagnostic system of the vehicle.

3. The method of claim 1, further comprising:
retrieving, by a diagnostic audio bridge coupled to an on-board diagnostic system of the vehicle, the velocity information from the on-board diagnostic system;
modulating, by a diagnostic audio bridge, the information into an audio signal;
transmitting, by a diagnostic audio bridge, the audio signal within the vehicle;
receiving, by a communication service operating on the personal communication device, the audio signal; and
demodulating, by the communication service, the audio signal to receive the velocity information.

4. The method of claim 3, wherein said transmitting comprises wirelessly transmitting.

5. The method of claim 1, wherein said deactivating comprises disabling a user interface of the personal communication device when the vehicle is in motion.

6. The method of claim 1, wherein said deactivating comprises turning off a communication radio of the personal communication device when the vehicle is in motion.

7. The method of claim 1, wherein said deactivating comprises muting a ringer of the personal communication device when the vehicle is in motion.

8. The method of claim 1, wherein said deactivating comprises activating a power saving mode of the personal communication device when the vehicle is in motion.

9. A safety system for partial deactivation of a personal communication device while a vehicle is in motion, wherein the vehicle includes an on-board diagnostic system, said safety system comprising:
a communication link for coupling to an audio interface of the personal communication device;
a diagnostic audio bridge, interfacing said communication link and for coupling to the on-board diagnostic system of the vehicle, wherein said diagnostic audio bridge retrieves velocity information of the vehicle from the on-board diagnostic system and transmits said velocity information via said communication link; and
activation control code, for executing on the personal communication device, which receives said velocity information and which deactivates at least one function of the personal communication device when the vehicle is in motion.

10. The safety system of claim 9, wherein said communication link comprises a wired electronic interface coupled to said diagnostic audio bridge and for coupling to an audio connector of the personal communication device.

11. The safety system of claim 9, wherein said communication link comprises a first wireless transceiver coupled to said diagnostic audio bridge and a second wireless transceiver for coupling to an audio connector of the personal communication device.

12. The safety system of claim 9, wherein said communication link comprises a wireless transmitter coupled to said diagnostic audio bridge and a wireless receiver for coupling to an audio connector of the personal communication device.

13. The safety system of claim 9, wherein said diagnostic audio bridge modulates said velocity information into an audio signal, and wherein said activation control code comprises a communication service which demodulates said audio signal to retrieve said velocity information.

14. The safety system of claim 9, wherein said activation control code comprises:
a velocity listening module which detects said velocity information and which determines when the vehicle is in motion; and
user interface control application, interfaced with said velocity listening module, deactivates at least one function of the personal communication device when the vehicle is in motion.

15. The safety system of claim 9, wherein said activation control code disables a user interface of the personal communication device when the vehicle is in motion.

16. The safety system of claim 9, wherein said activation control code turns off a communication radio of the personal communication device when the vehicle is in motion.

17. The safety system of claim 9, wherein said activation control code mutes a ringer of the personal communication device when the vehicle is in motion.

18. The safety system of claim 9, wherein said activation control code activates a power saving mode of the personal communication device when the vehicle is in motion.
